(19) United States
(12) Patent Application Publication
(10) Pub. No.: US 2020/0043322 A1
(43) Pub. Date: Feb. 6, 2020

(54) REMOTE CONTROL FOR WINDOW TREATMENT

(71) Applicant: Nien Made Enterprise Co., Ltd., Taichung (TW)

(72) Inventors: Chao-Hung Nien, Taichung (TW); Jui-Pin Jao, Miaoli County (TW); Yan-Liang Guo, Taipei City (TW); Tsu-Ya Huang, Hsinchu City (TW)

(21) Appl. No.: 16/525,596

(22) Filed: Jul. 30, 2019

(30) Foreign Application Priority Data
Aug. 1, 2018 (TW) 107210474

(51) Int. Cl. G08C 17/02; E06B 9/24

(52) U.S. Cl. CPC G08C 17/02; E06B 9/68; E06B 9/24

(57) ABSTRACT

A remote control used for opening and closing a covering assembly of an electric window treatment includes a main body, which includes a fixed unit, a rotating unit, and a detector. The fixed unit includes a first input unit which can be pressed. When the first input unit is pressed, it generates a first input signal to control the movement of the covering assembly. The rotating unit surrounds an external periphery of the fixed unit, and is rotatable relative to the fixed unit. The detector detects the rotation of the rotating unit relative to the fixed unit, and accordingly generates a second input signal to control the movement of the covering assembly. Whereby, a user can control the covering assembly in either way, and therefore the remote control is more flexible and convenient than conventional remote controls.

### BACKGROUND OF THE INVENTION

### 1. Field of the Invention

The present invention relates generally to a remote control which can be used to open or close the covering assembly of electric window treatment, and more particularly to a remote control which can be pressed and rotated for operation.

### 2. Description of the Prior Art

Conventionally, there are two ways to open and close the covering assembly of a window treatment: manually, or electrically. A manual-operated window treatment usually takes a cord as a medium for transferring the force exerted by the user to the control mechanisms in the headrail. However, an exposed cord may become looped and may cause a strangulation hazard. Some window covering manufacturers have developed window coverings without exposed cords to reduce said risk. Though this kind of window coverings is safer in use than corded ones, the operation of the covering assembly is limited by the height of the user, and therefore this apparently is also not an ideal solution. In addition, any manual operations for a covering assembly all require human power to counteract the weight of the covering assembly, which is quite strenuous. In recent years, the popularization of electric applications gradually facilitates the window covering industry to produce electrically-operated window coverings, which can overcome many drawbacks of manual-operated window coverings.

An electric window treatment is common to have an actuator provided in or near a headrail, and the actuator can be driven by commercial power or a battery. An output end of the actuator is an output axle, which is linked to a driving shaft, which is linked to the covering assembly. When the actuator is activated and rotated, the output axle is driven by the actuator to rotate, which drives the driving shaft to rotate, whereby to consequently move the covering assembly to be opened or closed; when the actuator stops rotating, the driving shaft also stops operating at the same time, and the covering assembly stays at a required open or close position as a result. Therefore, by controlling the actuator, the objective of operating (i.e., moving or stopping moving) the covering assembly of an electric window treatment can be achieved.

Since an actuator is provided in or near a headrail fixed at the top of a window, a user may not be able to directly control the operation of the actuator due to the out-of-reach height of its installed location. To fix this operating deficiency, some window covering manufacturers choose to extend the control interface of actuator to an available height, so that a user of medium height can access the control interface for operating the window covering. An example can be found in Taiwanese Patent TWM265461, wherein a main controller for controlling the operation of a motor is provided with a wire and a control device connected to the wire. With the wire, the control device can be suspended from a headrail to a convenient height. The control device has action buttons, including up, down, stop, set, etc. The signals generated by the action buttons can be transmitted to the main controller through the wire, whereby to control the motor to rotate clockwise or counterclockwise, or to stop the motor. However, since the control device is suspended by the wire at a lateral side of an electric window covering, the wire and the control device are exposed outside and may ruin the aesthetic completeness of the window covering. Furthermore, the wire has a certain length and therefore is also possible to become looped, which still poses the risk of strangulation.

As time goes on, the wireless communication technology which is prosperously developing nowadays is also applied in the field of the control of actuators. Basically speaking, a remote control which can be operated by a user and a main controller which can be utilized for the control of an actuator are provided separately. The remote control is provided with various action buttons. When any of the action buttons is pressed, corresponding signals will be generated and transmitted to the main controller in a wireless manner, and the actuator will perform actions correspondingly, as disclosed in Taiwanese Patent TWM265461. In order to transmit different action signals for different control of the actuator, the remote control can be provided with various action buttons, including up, down, stop, set, etc. However, when a user wants to fully open or fully close the covering assembly of an electric window covering, he or she has to keep pressing the corresponding action button for a period of time, which is inconvenient and troublesome. Furthermore, this kind of remote control has only one input method for generating and sending out the action signals to control an electric window treatment, which also limits the practicality of the remote control.

### SUMMARY OF THE INVENTION

In view of the above, the primary objective of the present invention is to provide a remote control, which can be operated by pressing a button thereof and by rotating a component thereof, whereby a user can control an electric window treatment in either way, depending on which one is preferred by the user. Therefore, the remote control is convenient and easy to use.

The present invention provides a remote control used for opening and closing a covering assembly of an electric window treatment. The remote control includes a main body, which includes a fixed unit, a rotating unit, and a detector. The fixed unit includes a base, a circuit board, and a first input unit, wherein the base has a bearing surface, which bears the circuit board and the first input unit. The first input unit is adapted to be operated to input a first input signal, which is to be transferred to the circuit board. The rotating unit is provided in a manner corresponding to the fixed unit, and is rotatable relative to the fixed unit, wherein the rotating unit is rotatable relative to the fixed unit from a first relative position to a second relative position over a moving distance. The detector is fixedly provided on the fixed unit; when the rotating unit starts to be rotated relative to the fixed unit from the first relative position, the detector is triggered and activated; when the rotating unit is rotated relative to the fixed unit to the second relative position and therefore is moved by the moving distance, the detector accordingly generates a second input signal, and transfers the second input signal to the circuit board. The circuit board is adapted to open or close the covering assembly of the electric window treatment according to the first input signal or the second input signal.

In an embodiment, the circuit board is provided between the base and the first input unit.

In an embodiment, the first input unit includes a button and a switch; the switch is coupled to the circuit board and is provided in a manner that, when the button is operated, the switch is activated at the same time to generate the first input signal, which is then transferred to the circuit board.

In an embodiment, the detector is coupled to the circuit board.

In an embodiment, the rotating unit includes a second input unit, which is provided relative to the fixed unit, and is rotatable relative to the fixed unit.

In an embodiment, the second input unit and the detector are mechanically connected. When the second input unit is operated to be rotated relative to the fixed unit by the moving distance, the detector generates the second input signal and transfers the second input signal to the circuit board.

In an embodiment, the second input unit surrounds the fixed unit, and is rotatable relative to the fixed unit.

In an embodiment, the second input unit is hollow and annular, and an inner annular surface of the second input unit includes a continuous toothed surface which is provided in a manner corresponding to the detector. The detector has a detecting shaft and a transmission gear fixedly provided in a manner that the transmission gear and the detecting shaft are coaxial. The transmission gear meshes with the continuous toothed surface. When the second input unit is operated to be rotated relative to the fixed unit, the continuous toothed surface drives the transmission gear and the detecting shaft to rotate, whereby the detector detects the moving distance when the second input unit is rotated relative to the fixed unit, and generates the second input signal then.

In an embodiment, the rotating unit further includes an operating element, which is connected to the second input unit, and is operable to drive the second input unit to rotate.

In an embodiment, the base has a holder provided on a bottom surface thereof, and the main body further includes an electric power storage member, which is detachably fixed at the holder, and is detachably coupled to the circuit board.

In an embodiment, the bottom surface of the base has a snap-fit groove, and the fixed unit further includes a bottom cover, which has an elastic snap-fit tongue; the elastic snap-fit tongue is adapted to snap-fit into the snap-fit groove, whereby to engage the bottom cover to the base.

In an embodiment, the remote controller further includes a fixed seat, and the main body further includes a first engaging unit provided on the bottom cover of the fixed unit; a second engaging unit is provided on the fixed seat in a manner that the second engaging unit corresponds to the first engaging unit. When the first engaging unit and the second engaging unit are engaged, the main body is fixed on the fixed seat through the bottom cover of the fixed unit.

In an embodiment, the first engaging unit includes a first magnetic member fixedly provided on the bottom cover; the second engaging unit includes a second magnetic member fixedly provided on the fixed seat, wherein the first magnetic member and the second magnetic member are provided correspondingly. When the first magnetic member attaches to the second magnetic member, the main body is fixed on the fixed seat.

In an embodiment, the first engaging unit further includes a recess, which is recessed into a bottom surface of the bottom cover; the recess has an inner surface, and a first stop portion is formed along the inner surface; the second engaging unit further includes a protrusion, of which an outline matches a shape of the inner surface; the protrusion has a second stop portion corresponding to the first stop portion; when the protrusion enters the recess, the first stop portion matches the second stop portion, and therefore the main body is unmovable and not rotatable relative to the fixed seat.

In an embodiment, the main body further includes an identifying ring, which optionally and fixedly surrounds the fixed unit, so that the rotating unit is rotatable relative to the identifying ring.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will be best understood by referring to the following detailed description of some illustrative embodiments in conjunction with the accompanying drawings, in which

FIG. 1 is a perspective view of the main body and the fixed seat of the remote control, which is viewed from the side;

FIG. 2 is a perspective view of the main body of the present invention;

FIG. 3 is a perspective view of the main body of the present invention viewed from another angle;

FIG. 4 is an exploded view of the main body of the present invention;

FIG. 5 is an exploded view of the main body of the present invention viewed from another angle;

FIG. 6A is a planar schematic view showing how the circuit board, the second input unit and the base of the main body of the present invention are connected;

FIG. 6B is a planar schematic view showing how the detector, the second input unit and the base are connected, with the circuit board shown in FIG. 6A omitted;

FIG. 7 is a longitudinal section of the main body of the present invention;

FIG. 8A is a schematic view showing the usage condition that the fixed seat of the present invention is fixed on a wall;

FIG. 8B is a schematic view showing the usage condition that the main body of the present invention is disposed on a wall by being attached to the fixed seat shown in FIG. 8A;

FIG. 9 is a schematic view showing the usage condition that the main body of the present invention is fixed on the fixed seat; and

FIG. 10 is a longitudinal section of the whole set illustrated in FIG. 9.

### DETAILED DESCRIPTION

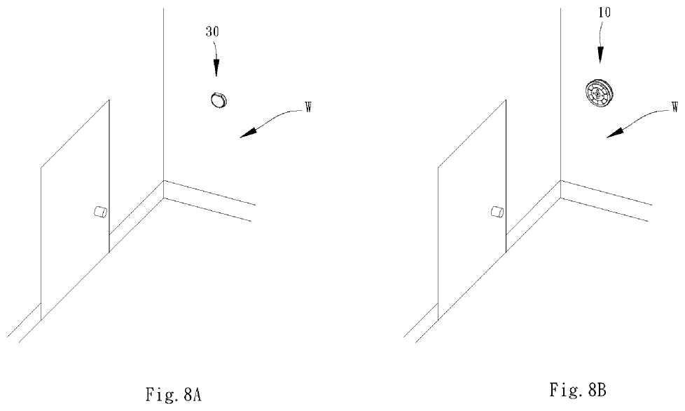

As shown in FIG. 1, a window treatment remote control 100 of the present invention includes a main body 10 and a fixed seat 30, wherein the main body 10 can be used to input action instructions for an electric window treatment (not shown), and is capable of transmitting an action signal to the electric window treatment, whereby to open or close a covering assembly of the electric window treatment. The fixed seat 30 could be fixedly provided on a fixed surface such as a wall, as shown in FIG. 8A. The main body 10 is adapted to be engaged with the fixed seat 30, so that the main body 10 could be fixed on a fixed surface, as shown in FIG. 8B.

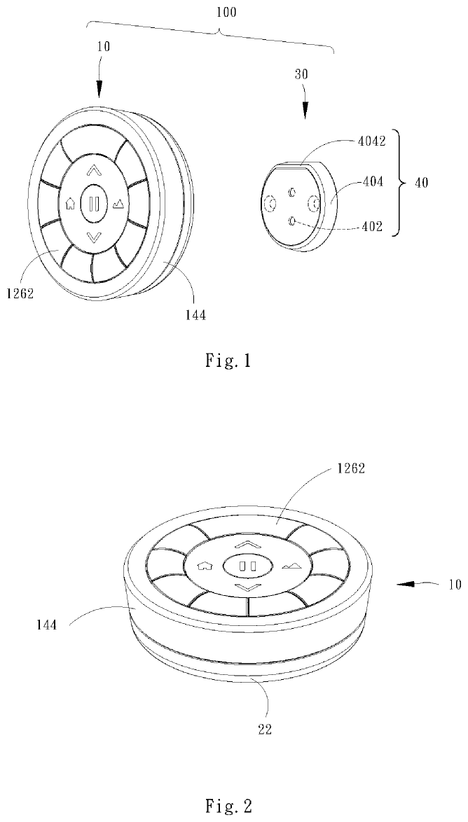

As illustrated in FIG. 2 to FIG. 5, the main body 10 at least includes a fixed unit 12, a rotating unit 14, a detector 16, an electric power storage member 18, and a bottom cover 20. The fixed unit 12 further includes a base 122, a circuit board 124, and a first input unit 126, wherein the base 122 has a bearing surface 1222, which sequentially bears the circuit board 124 and the first input unit 126. The base 122 is made to have a holder 1224. The electric power storage member 18 could be detachably fixed to the holder 1224, and could be detachably coupled with the circuit board 124. When the electric power storage member 18 is fixed in the holder 1224 and is coupled with the circuit board 124, the electric power storage member 18 provides the power required by the circuit board 124. The electric power storage member 18 and the circuit board 124 could be coupled in various ways, such as through the coupling between coupling points or through the coupling between a conductive plate and a coupling point. In addition, the base 122 has a snap-fit groove 1226. In the current embodiment, the snap-fit groove 1226 is provided on a bottom surface of the base 122. However, this is not a limitation of the present invention. The first input unit 126 includes a button 1262 and a switch 1264, wherein the button 1262 is fixedly provided on a panel 128, and the circuit board 124 is disposed between the panel 128 and the base 122. Specifically, the circuit board 124, the panel 128, and the base 122 are engaged in an unmovable and non-rotatable manner. In the current embodiment, the switch 1264 is, for modularization, fixed on the circuit board 124 and is coupled with the circuit board 124. The switch 1264 is provided in a manner corresponding to the button 1262, whereby, when the button 1262 is pressed, the switch 1264 could be triggered to generate a first input signal. However, the arrangements of the button 1262 and the switch 1264 are not limited to the examples described herein; any arrangements making the operation of the button 1262 trigger the switch 1264 to operate would be considered fall within the scope of the present invention. In addition, the numbers of the button 1262 and the switch 1264 can be more than one as required and are not limited to be only one.

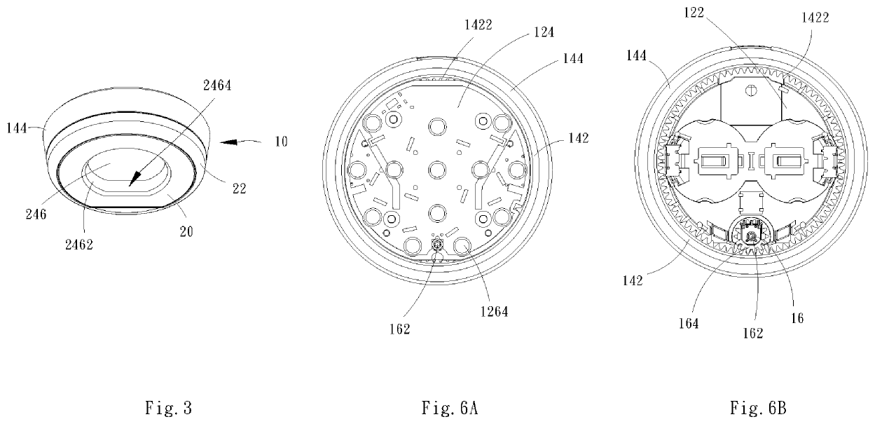

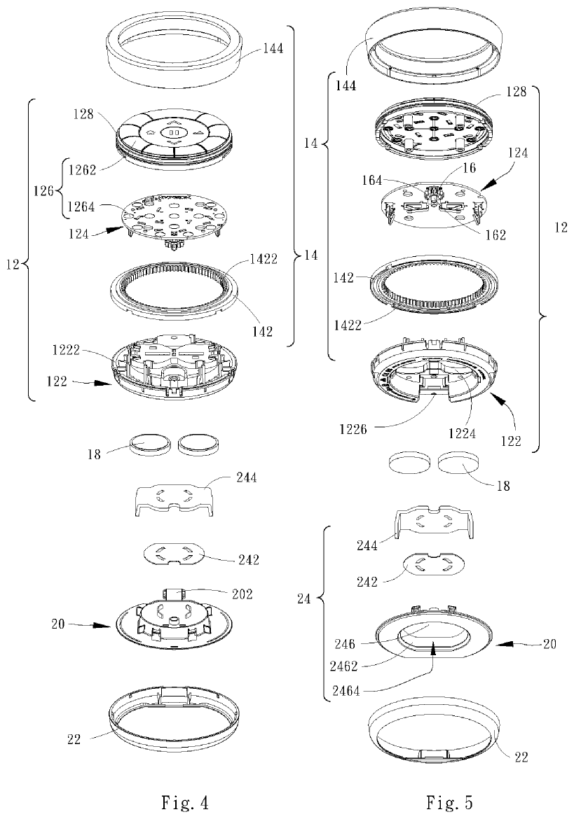

The detector 16 is fixedly provided at the fixed unit 12, and is coupled with the circuit board 124. In the current embodiment, in order to modularize the components and to make the overall size compact, the detector 16 is fixedly provided on the circuit board 124; however, this is not a limitation of the present invention. For example, the detector 16 could be fixed on other components of the fixed unit 12 instead, and still coupled to the circuit board 124. The detector 16 has a detecting shaft 162, wherein a transmission gear 164 fixedly provided around the detecting shaft 162 in a coaxial manner. The rotating unit 14 at least includes a second input unit 142. In the current embodiment, the second input unit 142 is hollow and annular, and fits around an outer periphery of the circuit board 124 and the base 122. The second input unit 142 is rotatable relative to the circuit board 124 and the base 122, i.e., is rotatable relative to the fixed unit 12. However, this is not a limitation of the present invention. In other embodiments, the second input unit 142 could be provided on the circuit board 124 instead, or, as oppositely arranged, the circuit board 124 fits around an outer periphery of the second input unit 142, and the second input unit 142 could be rotated relative to the circuit board 124. In other words, the structures that the second input unit 142 is rotatable relative to the fixed unit 12 should be also considered fall within the scope of the present invention. An inner annular surface of the second input unit 142 at least includes a continuous toothed surface 1422. In the current embodiment, the continuous toothed surface 1422 is a complete annulus and is provided on the inner annular surface of the second input unit 142 without having intervals. However, in other embodiments, the continuous toothed surface 1422 provided on the inner annular surface of the second input unit could be divided into multiple segments with intervals therebetween. The continuous toothed surface 1422 meshes with the transmission gear 164, so that when the second input unit 142 is operated to rotated relative to the static circuit board 124, the continuous toothed surface 1422 of the second input unit 142 would drive the transmission gear 164 to rotate, whereby the linked detecting shaft 162 could detect the relative moving distance generated during the rotation of the second input unit 142, by which the detector 16 could generate a second input signal, as seen in FIG. 6B. In the current embodiment, an outer annular surface of the second input unit 142 is connected to an operating element 144, wherein the operating element 144 could be a grip-like design (not shown) connected to the outer annular surface of the second input unit 142, or the operating element 144 could be a hollow annulus fitting around the outer annular surface of the second input unit 142 and fixedly connected to the second input unit 142, whereby, when the operating element 144 is operated, the second input unit 142 could be driven to rotate.

A bottom cover 20 is substantially round and flat, and has an elastic snap-fit tongue 202, which is provided in a manner corresponding to the snap-fit groove 1226 of the base 122. When the bottom cover 20 is engaged with the bottom surface of the base 122, the elastic snap-fit tongue 202 could snap-fit into the snap-fit groove 1226 of the base 122, whereby the bottom cover 20 could be firmly engaged with the base 122.

The main body 10 further includes an identifying ring 22, which is hollow and annular, and optionally fits around an outer periphery of the fixed unit 12 to be fixed therearound. In the current embodiment, the identifying ring 22 is fixed around an outer periphery of the bottom cover 20, so that the identifying ring 22 is provided in a manner corresponding to the operating element 144 which is provided around the outer periphery of the fixed unit 12 in an axial direction of the fixed unit 12, forming the whole main body 10 together. The identifying ring 22 could be any color as required, and could be optionally fixed around the outer periphery of the fixed unit 12, whereby, if there is more than one main body provided for controlling more than one electric window treatment, each of said main bodies can be identified through the identifying ring 22.

The main body 10 further includes a first engaging unit 24 provided on the bottom cover 20, wherein the first engaging unit 24 includes a first magnetic member 242 and a fixing plate 244. The first magnetic member 242 is provided between the fixing plate 244 and the bottom cover 20, and the fixing plate 244 is fixedly connected to the bottom cover 20, whereby the first magnetic member 242 could be fixed to the bottom cover 20. However, this is not a limitation of the present invention. In other embodiments, the first magnetic member 242 could be directly glued to the bottom cover 20 instead, or could be fixed to the bottom cover 20 by other means. The first engaging unit 24 further includes a recess 246, which is recessed into a bottom surface of the bottom cover. The recess 246 has an inner surface 2462, and a first stop portion 2464 provided along the inner surface 2462.

The fixed seat 30 could be fixed to a fixed surface, such as a wall shown in FIG. 8A to FIG. 10, through a screw or other fasteners alike. A second engaging unit 40 is provided in the fixed seat 30, wherein the second engaging unit 40 includes a second magnetic member 402 which is provided in a manner corresponding to the first magnetic member 242, and is fixed to the fixed seat 30. The second magnetic member 402 can be fixed to the fixed seat 30 in various ways such as gluing, and the first magnetic member 242 and the second magnetic member 402 attract each other. The second engaging unit 40 further includes a protrusion 404, which has an outline matching the shape of the inner surface 2462 of the recess 246. The protrusion 404 further has a second stop portion 4042, and the second stop portion 4042 and the first stop portion 2464 correspond to each other. When the protrusion 404 fits into the recess 246, the first stop portion 2464 abuts against the second stop portion 4042, providing a fixing effect, and therefore the bottom cover 20 is not rotatable relative to the fixed seat 30. In the current embodiment, the protrusion 404 and the fixed seat 30 can be combined as a whole, i.e., when the fixed seat 30 is fixed to the fixed surface, the fixed seat 30 becomes a protrusion protruding from the fixed surface, and therefore can fit into the recess 246 of the main body 10.

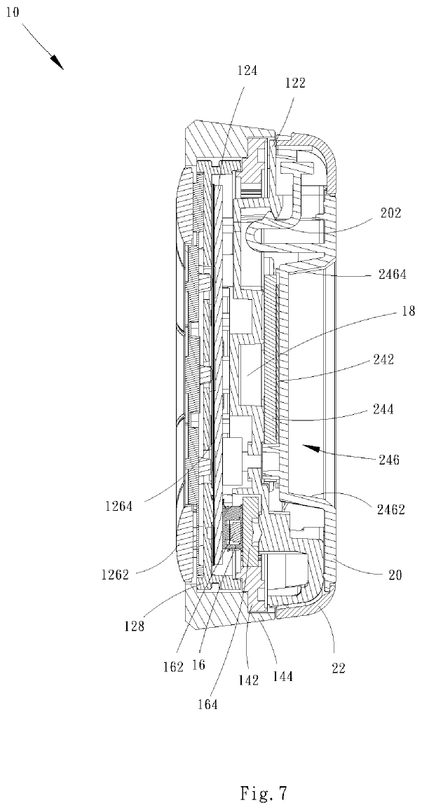

As shown in FIG. 6 and FIG. 7, the main body 10 of the remote control 100 is adapted to have two ways to be operated for generating input signals. FIG. 6A is a 2D schematic view showing how the circuit board 124 and the second input unit 142 are connected to the base 122, while FIG. 6B is another 2D schematic view served for the same purpose with the circuit board 124 omitted. The first way for inputting is to press the button 1262 provided on the panel 128, where the pressed button 1262 would trigger the switch 1264 fixed on the circuit board 124, whereby the switch 1264 could generate the first input signal, which could be then transmitted to the circuit board 124 coupled to the switch 1264, so that a control signal could be transmitted to an electric window treatment through the circuit board 124 to open or close the covering assembly thereof. The second way for inputting is to rotate the operating element 144 fitting around the outer periphery of the fixed unit 12, which would make the operating element 144 drive the second input unit 142 to rotate relative to the fixed unit 12. Consequently, the second input unit 142 would also drive the transmission gear 164 to rotate, so that the detector 16 coaxially provided with the transmission gear 164 could detect the moving distance of the rotation, whereby to generate the second input signal. In more details, when the operating element 144 drives the second input unit 142 to start rotating relative to the fixed unit 12, the second input unit 142 starts rotating from a first relative position which is defined by referencing the fixed unit 12; at this time, the transmission gear 164 and the detecting shaft 162 would start to rotated correspondingly as well, so that the detector 16 could be trigger and activated to start detecting. Once the second input unit 142 stops rotating and stays at a second relative position, which is also defined by referring the fixed unit 12, the detector 16 stops detecting. In other words, the rotation of the second input unit 142 between the first relative position and the second relative position could drive, in a linked manner, the detecting shaft 162 of the detector 16 to rotate, and the detector 16 would generate the second input signal and send it to the circuit board 124 once the moving distance across the first relative position and the second relative position has been successfully detected by the detecting shaft 162. In this way, the circuit board 124 could transmit a control signal to an electric window treatment to open or close the covering assembly thereof. In the current embodiment, the mapping between the moving distance and the operation of the covering assembly could be correspondingly determined, and some functions can be further defined. For example, the operation of the covering assembly could be defined as fully open or fully close in the case when the moving distance is greater than a predetermined distance, say one-third of the circumference of the outer edge of the fixed unit 12. The mapping between the moving distance and the operation of the covering assembly is, nevertheless, limited by the above example; as long as the moving distance relates to the operation of the covering assembly, any mapping manners should fall within the scope of the present invention.

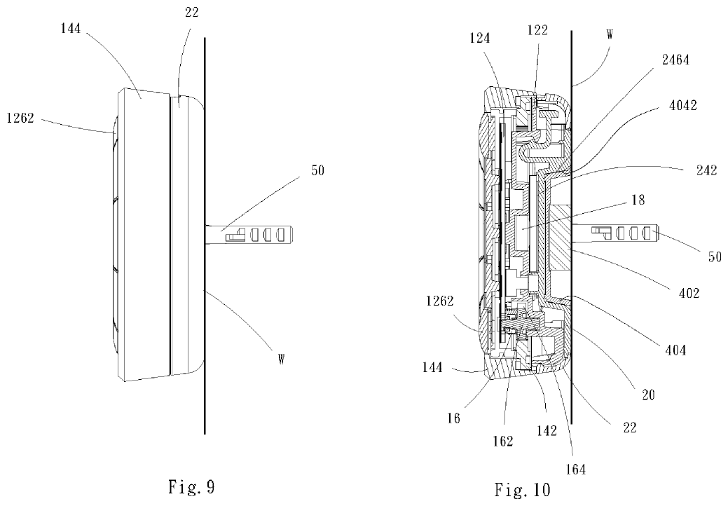

FIG. 8A illustrates the condition when the fixed seat 30 of the remote control 100 of the present invention is secured on a wall W, and FIG. 8B illustrates the condition when the main body 10 of the remote control 100 of the present invention is fixed on the wall W by attaching to the fixed seat 30 shown in FIG. 8A. As shown in FIG. 9 and FIG. 10, a screw set 50 passes through the fixed seat 30 to be screwed into the wall W, whereby the fixed seat 30 could be firmly fixedly on the wall W, and the remote control 100 is detachably connected to the fixed seat 30. When the main body 10 of the remote control 100 is engaged with the fixed seat 30, the recess 246 provided on the bottom cover 20 of the main body 10 corresponds to the protrusion 404 provided on the fixed seat 30, i.e., the protrusion 404 fits into the recess 246. At this time, the first stop portion 2464 provided on the inner surface 2462 of the recess 246 works with the second stop portion 4042 of the protrusion 404 to provide a fixing effect. As a result, the main body 10 would be unmovable and not rotatable relative to the fixed seat 30, whereby the main body 10 is fixed onto the fixed seat 30. In addition, when the main body 10 is fixed to the fixed seat 30, the first magnetic member 242 fixedly provided at the bottom cover 20 of the main body 10 and the second magnetic member 402 fixedly provided on the fixed seat 30 could attract each other, which could enhance the engagement between the main body 10 and the fixed seat 30. In this way, the main body 10 could be securely attached to the wall W.

To open or close the covering assembly of an electric window treatment, a user could choose to hold the main body 10 in the hand or keep the main body 10 fixed to the fixed seat 30, and could choose to press the button 1262 or to rotate the operating element 144 relative to the fixed unit 12. In any of the above ways, the main body 10 could be used to transmit control signals to the electric window treatment in a wireless manner, whereby to operate the covering assembly. With the present invention, a user could use the main body 10 either with it held in hand or with it fixed to the fixed seat 30, depending on his or her preference or requirements, and could use any of the two ways, by pressing the button 1262 or by rotating the operating element 144, to input signals for operating the electric window treatment. Whereby, there could be various ways of operation to meet different operational needs. In addition, when the main body 10 is fixed to the fixed seat 30, these components are engaged by fitting the protrusion 404 provided on the fixed seat 30 into the recess 246 of the main body 10, and therefore the main body 10 would be the only portion protruding from the wall, which could reduce the chances of unintentional knocking-downs of the remote control.

It must be pointed out that the embodiments described above are only some preferred embodiments of the present invention. All equivalent structures which employ the concepts disclosed in this specification and the appended claims should fall within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A remote control used for opening and closing a covering assembly of an electric window treatment, comprising:
a main body, which comprises:
a fixed unit comprising a base, a circuit board, and a first input unit, wherein the base has a bearing surface, which bears the circuit board and the first input unit; the first input unit is adapted to be operated to input a first input signal, which is to be transferred to the circuit board;
a rotating unit, which is provided in a manner corresponding to the fixed unit, and is rotatable relative to the fixed unit, wherein the rotating unit is rotatable relative to the fixed unit from a first relative position to a second relative position over a moving distance; and
a detector, which is fixedly provided on the fixed unit; when the rotating unit starts to be rotated relative to the fixed unit from the first relative position, the detector is triggered and activated; when the rotating unit is rotated relative to the fixed unit to the second relative position and therefore is moved by the moving distance, the detector accordingly generates a second input signal, and transfers the second input signal to the circuit board;
wherein, the circuit board is adapted to open or close the covering assembly of the electric window treatment according to the first input signal or the second input signal.

2. The remote control of claim 1, wherein the circuit board is provided between the base and the first input unit.

3. The remote control of claim 1, wherein the first input unit comprises a button and a switch; the switch is coupled to the circuit board and is provided in a manner that, when the button is operated, the switch is activated at the same time to generate the first input signal, which is then transferred to the circuit board.

4. The remote control of claim 1, wherein the detector is coupled to the circuit board.

5. The remote control of claim 1, wherein the rotating unit comprises a second input unit, which is provided relative to the fixed unit, and is rotatable relative to the fixed unit.

6. The remote control of claim 5, wherein the second input unit and the detector are mechanically connected; when the second input unit is operated to be rotated relative to the fixed unit by the moving distance, the detector generates the second input signal and transfers the second input signal to the circuit board.

7. The remote control of claim 6, wherein the second input unit surrounds the fixed unit, and is rotatable relative to the fixed unit.

8. The remote control of claim 7, wherein the second input unit is hollow and annular, and an inner annular surface of the second input unit comprises a continuous toothed surface which is provided in a manner corresponding to the detector; the detector has a detecting shaft and a transmission gear fixedly provided in a manner that the transmission gear and the detecting shaft are coaxial; the transmission gear meshes with the continuous toothed surface; when the second input unit is operated to be rotated relative to the fixed unit, the continuous toothed surface drives the transmission gear and the detecting shaft to rotate, whereby the detector detects the moving distance when the second input unit is rotated relative to the fixed unit, and generates the second input signal then.

9. The remote control of claim 5, wherein the rotating unit further comprises an operating element, which is connected to the second input unit, and is operable to drive the second input unit to rotate.

10. The remote control of claim 1, wherein the base has a holder provided on a bottom surface thereof, and the main body further comprises an electric power storage member, which is detachably fixed at the holder, and is detachably coupled to the circuit board.

11. The remote control of claim 1, wherein the bottom surface of the base has a snap-fit groove, and the fixed unit further comprises a bottom cover, which has an elastic snap-fit tongue; the elastic snap-fit tongue is adapted to snap-fit into the snap-fit groove, whereby to engage the bottom cover to the base.

12. The remote control of claim 1, further comprising a fixed seat, wherein the main body further comprises a first engaging unit provided on the bottom cover of the fixed unit; a second engaging unit is provided on the fixed seat in a manner that the second engaging unit corresponds to the first engaging unit; when the first engaging unit and the second engaging unit are engaged, the main body is fixed on the fixed seat through the bottom cover of the fixed unit.

13. The remote control of claim 12, wherein the first engaging unit comprises a first magnetic member fixedly provided on the bottom cover; the second engaging unit comprises a second magnetic member fixedly provided on the fixed seat, wherein the first magnetic member and the second magnetic member are provided correspondingly; when the first magnetic member attaches to the second magnetic member, the main body is fixed on the fixed seat.

14. The remote control of claim 12, wherein the first engaging unit further comprises a recess, which is recessed into a bottom surface of the bottom cover; the recess has an inner surface, and a first stop portion is formed along the inner surface; the second engaging unit further comprises a protrusion, of which an outline matches a shape of the inner surface; the protrusion has a second stop portion corresponding to the first stop portion; when the protrusion enters the recess, the first stop portion matches the second stop portion, and therefore the main body is unmovable and not rotatable relative to the fixed seat.

15. The remote control of claim 1, wherein the main body further comprises an identifying ring, which optionally and fixedly surrounds the fixed unit, so that the rotating unit is rotatable relative to the identifying ring.
